(19) United States
(12) Patent Application Publication
(10) Pub. No.: US 2018/0247203 A1
(43) Pub. Date: Aug. 30, 2018

(54) DYNAMIC PROBLEM ASSIGNMENT

(71) Applicant: INTERNATIONAL BUSINESS MACHINES CORPORATION, Armonk, NY (US)

(72) Inventors: AL CHAKRA, APEX, NC (US); MICHAEL P. CLARKE, ELLENBROOK (AU); MATT R. HOGSTROM, RALEIGH, NC (US)

(21) Appl. No.: 15/444,852

(22) Filed: Feb. 28, 2017

(51) Int. Cl. G06N 5/02; G06N 99/00

(52) U.S. Cl. CPC G06N 5/02; G06N 99/005

(57) ABSTRACT

Embodiments include method, systems and computer program products for dynamic problem assignment. Aspects include receiving a data set from a computer system and detecting a problem based on the data set. A problem signature is generated based on the problem and is transmitted to a plurality of cognitive engines. A plurality of bids from the plurality of analytics engines is received and a bid from the plurality of bids is selected. An activity to intervene on the problem is initiated, the activity is determined based on the selected bid.

### BACKGROUND

The present disclosure relates to data processing, and more specifically, to methods, systems and computer program products for dynamically assigning a problem to a cognitive engine for resolution.

Data analysis techniques become increasing sophisticated to meet the needs of computing systems that generate large data sets, known as “big data.” Big data is often too large or complex that traditional data processing techniques are inadequate. Challenges associated with handling big data include, but not limited to, data analysis, capture, search, sharing, storage, transfer visualization, querying, updating, and information privacy. Different types of data analysis techniques are applied to big data to derive value from the data.

### SUMMARY

In accordance with an embodiment, a method for dynamic problem assignment is provided. The method includes receiving a data set from a computer system and detecting a problem based on the data set. A problem signature is generated based on the problem and is transmitted to a plurality of cognitive engines. A plurality of bids from the plurality of analytics engines is received and a bid from the plurality of bids is selected. An activity to intervene on the problem is initiated, the activity is determined based on the selected bid.

In another embodiment, a computer program product may comprise a non-transitory storage medium readable by a processing circuit that may store instructions for execution by the processing circuit for performing a method that includes receiving a data set from a computer system and detecting a problem based on the data set. A problem signature is generated based on the problem and is transmitted to a plurality of cognitive engines. A plurality of bids from the plurality of analytics engines is received and a bid from the plurality of bids is selected. An activity to intervene on the problem is initiated, the activity is determined based on the selected bid.

In another embodiment, a system may include a processor in communication with one or more types of memory. The processor is configured to receive a data set from a computer system and detect a problem based on the data set. The processor is also configured to generate a problem signature based on the problem and to transmit the problem signature to a plurality of cognitive engines. The processor is further configured to receive a plurality of bids from the plurality of analytics engines and to select a bid from the plurality of bids. The processor is configured to initiate an activity to intervene on the problem, the activity is determined based on the selected bid.

### BRIEF DESCRIPTION OF THE DRAWINGS

The forgoing and other features, and advantages of the disclosure are apparent from the following detailed description taken in conjunction with the accompanying drawings in which:

FIG. 1 is a block diagram illustrating one example of a processing system for practice of the teachings herein;

FIG. 2 is a block diagram illustrating a computing system in accordance with an exemplary embodiment; and

FIG. 3 is a flow diagram of a method for dynamic problem assignment in accordance with an exemplary embodiment.

### DETAILED DESCRIPTION

In accordance with exemplary embodiments of the disclosure, methods, systems and computer program products for dynamic problem assignment are provided. The systems and methods described herein are directed to detecting a failure in, or a problem with, a complex computing environment and facilitating selection of a cognitive engine to fix the detected failure in near real time. In complex computing environments, multiple cognitive engines and analytic engines can be utilized to identify and solve a problem. Typically, an analytic engine is used to identify a problem by applying statistical, numerical or computational methods to the large volume of data to discover abnormalities that are buried in the data. Once a problem has been identified a cognitive engine can be selected to attempt to solve the problem. However, each cognitive engine has different strengths and weaknesses and may best suited to solve different types of problems. Unfortunately, a unique constraint of these complex computing environments is that only a single attempt to fix a problem is ideal as the attempt may make the problem worse, so it is important to find the best situated cognitive engine to work on the problem.

The systems, methods and computer program products described herein are directed to identifying a problem by analyzing big data generated by computing systems. In exemplary embodiments, a problem in the complex computing environment is identified by one or more analytic engines, which generate a problem signature for the problem that includes data regarding the nature or type of the problem identified. One or more problem auctioneer servers are configured to receive the problem signatures from the analytic engines. In exemplary embodiments, the problem auctioneer can obtain additional parameters associated with the problem signature based on information associated with the computing system, such as a service level agreement specifying that problems need to be addressed within an identified time period (e.g., within 48 hours).

The problem auctioneer server can utilize a blind bidding process to select a cognitive engine to solve the problem. Initially, the problem signature and associated data will be routed to all of the cognitive engines so they can each generate a bid statement. In some embodiments, the bid statement, or bid, can include a confidence score calculated by the cognitive engines that reflect the confidence that the cognitive engines can resolve the problem. The confidence score is based on one or more of the expected cost for the cognitive engine to resolve the problem, the expected time for the cognitive engine to resolve the problem and a confidence level that the cognitive engine can resolve the problem. The problem auctioneer server receives bids from multiple cognitive engines. In some embodiments, the problem auctioneer server can discard some of the bids using predetermined criteria. The problem auctioneer can then assign the problem to the best bid statement received from one of the cognitive engines. In exemplary embodiments, the best bid statement can be the bid that includes the lowest cost, the fastest resolution, the highest confidence, or a combination thereof. If none of the bid statements received from the cognitive engines exceed a minimum threshold of cost, resolution time, or resolution confidence, the problem may be flagged for examination by a person for resolution. In the event of two or more bid statements result in a tie, a simple tie breaker algorithm can be used, such as each tied bidder each increases their bid by a random value between 1 and 100, repeating until there is only one winner. In exemplary embodiments, cognitive engines are expected to remember the results of previous winning bids and can use these to adjust their confidence values (100 if it worked, 0 if it failed).

In exemplary embodiments, the problem auctioneer server can generate the problem signature and control the auction process. The cognitive engines registered with the auctioneer will be notified of the problem and requested to submit a bid. In some embodiments, a user-modifiable time limit on the bid may be set (e.g., 3 seconds). The cognitive engines can each research the problem, find potential solutions and derive a confidence factor for how well the solutions they have found will address the problem. The cognitive engines can then respond to the auctioneer with their bid. If a cognitive engine does not respond with a bid in time, it is eliminated from the auction. Once the auctioneer has received all the bids, it will apply a user specifiable minimum confidence level (e.g., ‘reserve’) and eliminate all cognitive engines that bid under that value. If there are any cognitive engines left, it will take the one with the best bid and award it the job of fixing the problem. In the event of a tie, each of the tied bids will be increased by adding a value from 1 to 100 until a winner emerges. Cognitive engines are expected to keep track of their previous behavior. If the problem matches one they have earlier fixed, they can have 100% confidence. If a solution previously failed, they should not propose it. In exemplary embodiments, the auctioneer is configured to assess the outcome of each cognitive engine to determine how the performance of the cognitive engine in solving problems it was previously assigned. In this manner, the auctioneer can determine which cognitive engines bids are trustworthy.

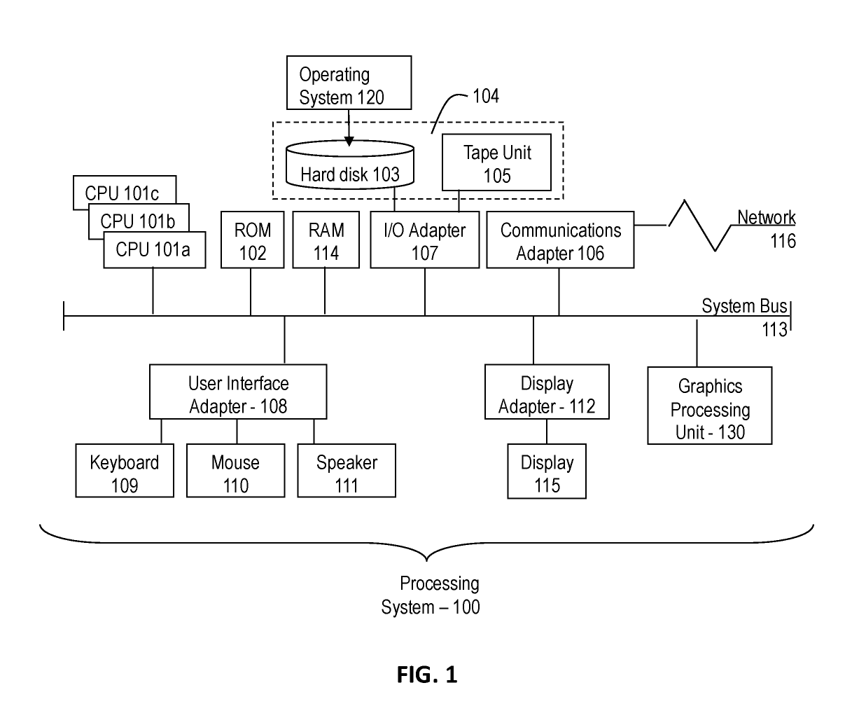

FIG. 1 further depicts an input/output (I/O) adapter 107 and a communications adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. Operating system 120 for execution on the processing system 100 may be stored in mass storage 104. A communications adapter 106 interconnects bus 113 with an outside network 116 enabling data processing system 100 to communicate with other such systems. A screen (e.g., a display monitor) 115 is connected to system bus 113 by display adapter 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 113 via user interface adapter 108 and display adapter 112. A keyboard 109, mouse 110, and speaker 111 all interconnect to bus 113 via user interface adapter 108, which may include, for example, a Super I/O chip integrating multiple device adapters into a single integrated circuit.

In exemplary embodiments, the processing system 100 includes a graphics-processing unit 130. Graphics processing unit 130 is a specialized electronic circuit designed to manipulate and alter memory to accelerate the creation of images in a frame buffer intended for output to a display. In general, graphics-processing unit 130 is very efficient at manipulating computer graphics and image processing and has a highly parallel structure that makes it more effective than general-purpose CPUs for algorithms where processing of large blocks of data is done in parallel.

Thus, as configured in FIG. 1, the system 100 includes processing capability in the form of processors 101, storage capability including system memory 114 and mass storage 104, input means such as keyboard 109 and mouse 110, and output capability including speaker 111 and display 115. In one embodiment, a portion of system memory 114 and mass storage 104 collectively store an operating system such as the AIX® operating system from IBM Corporation to coordinate the functions of the various components shown in FIG. 1.

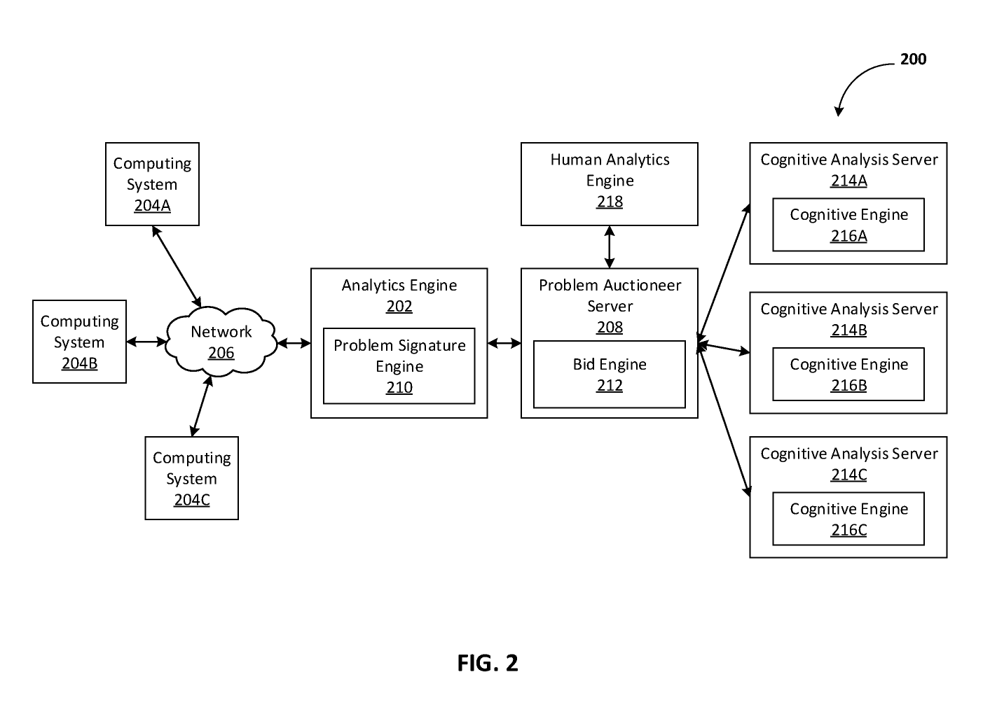

Referring now to FIG. 2, a computing system 200 in accordance with an embodiment is illustrated. As illustrated, the computing system 200 can include, but is not limited to, one or more computing systems 204A, 204B, 204C (collectively referred to as computing systems 204), an analytic engine 202, a problem auctioneer server 208, and/or one or more cognitive analysis servers 214A, 214B, 214C (collectively referred to as 204) connected via one or more networks 206.

The computing system 204 can be any type of computing devices, such as a mainframe computer, computer, laptop, tablet, smartphone, wearable computing device, server, etc. capable of generating big data. The computing system 204 can be capable of communicating with other devices over one or more networks 206. The computing system 204 can be able to execute applications and tools used to develop one or more applications.

The network(s) 206 can include, but are not limited to, any one or a combination of different types of suitable communications networks such as, for example, cable networks, public networks (e.g., the Internet), private networks, wireless networks, cellular networks, or any other suitable private and/or public networks. Further, the network(s) 206 can have any suitable communication range associated therewith and can include, for example, global networks (e.g., the Internet), metropolitan area networks (MANs), wide area networks (WANs), local area networks (LANs), or personal area networks (PANs). In addition, the network(s) 206 can include any type of medium over which network traffic can be carried including, but not limited to, coaxial cable, twisted-pair wire, optical fiber, a hybrid fiber coaxial (HFC) medium, microwave terrestrial transceivers, radio frequency communication mediums, satellite communication mediums, or any combination thereof.

In some embodiments, the analytic engine 202 and the problem auctioneer server 208 can be embodied in any type of computing device with network access, such as a computer, laptop, server, tablet, smartphone, wearable computing devices, or the like. The analytic engine 202 is configured to receive data from the computing system 204 via the network 206 and to identify a problem or failure in the computing systems 204. The analytic engine 202 includes a problem signature engine 210 that creates a problem signature based on the identified problem. The problem auctioneer server 208 includes a bid engine 212 that receives the problem signature from the problem signature engine 210 and which transmits the problem signature to the cognitive analysis servers 214.

The analytic engine 202 and problem signature engine 210 can include computer-readable instructions that in response to execution by the processor(s) 101, cause operations to be performed including receiving data from one or more computing systems 204 and analyzing the received the data. The problem signature engine 210 detects a problem based on the analyzed data and generates a problem signature. A problem signature is indicative of a detected problem correlated with one or more sources (e.g., a database lock error with a storage error). In some embodiments, the problem signature engine 210 can generate or derive parameters associated with the problem signature from the computing system 204 that generated the big data (e.g., type of operating system, applications, hardware identification, service level agreement, etc.). The parameters can be indicative of constraints associated with the generated problem signature (e.g., time period when the problem needs to be addressed). The bid engine 212 identifies cognitive analysis servers 214 that are registered with the problem auctioneer server 208 and transmits the problem signature and parameters to solicit bids. In some embodiments, the bid engine 212 can determine that the generated problem signature is the same or within a threshold of a previously identified problem signature and can select the cognitive analysis server 214 that handled the previous problem rather than soliciting bids from all the cognitive analysis servers 214.

The bid engine 212 can include computer-readable instructions that in response to execution by the processor(s) 101, cause operations to be performed including receiving bids from one or more cognitive analysis servers. The bid engine 212 can discard bids that do not meet predetermine criteria. The bid engine 212 selects a bid from the remaining bids and transmits the big data from which the problem was detected to the selected cognitive analysis server 214. If the bid engine 212 determines that no bids are remaining, the problem signature can be transmitted to a human analysis system 218 for analysis by a person. In some embodiments, the bid engine 212 can determine that the selected cognitive analysis server 214 cannot fix the problem or reach a resolution. The bid engine 212 can then reassign the problem to one of the remaining bids or solicit new bids.

In some embodiments, the cognitive analysis server 214 can be any type of computing device with network access, such as a computer, laptop, server, tablet, smartphone, wearable computing devices, or the like. The cognitive analysis servers 214A, 214B, and 214C can include cognitive engines 216A, 216B, and 216C, respectively (generically referred to as cognitive engine 216).

The cognitive engine 216 can include computer-readable instructions that in response to execution by the processor(s) 101, cause operations to be performed including researching the problem identified in the problem signature, searching the history for similar problems, estimating a resolution to the identified problem, generating a bid, and transmitting the bid to the bid engine 212. In some embodiments, the analytics engine can generate a confidence score. The confidence score is a numeric indication of the probability that the cognitive engine 216 can resolve the identified problem. The confidence score can be generated using different factors, such as previous resolution attempts, type of problem, consideration of identified parameters, and the like.

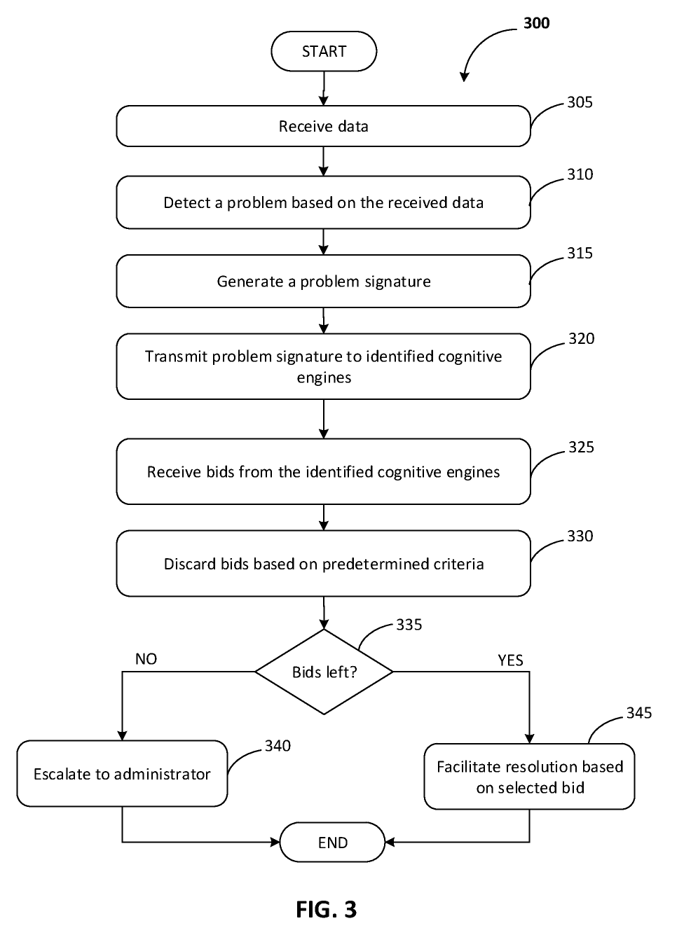

Now referring to FIG. 3, a flow diagram of a method 300 for dynamic problem assignment in accordance with an exemplary embodiment is depicted. At block 305, data is received from a complex computing system. In some embodiments, one or more computing systems 204 can generate and transmit big data to the analytics engine 202.

At block 310, a problem is detected based on the received data. The problem signature engine 210 analyzes the data and detects one or more problems or potential problems. In some embodiments, the problem signature engine 210 can detect problem using machine learning techniques.

At block 315, a problem signature is generated. The problem signature engine 210 can generate a problem signature using the detected problem. The problem signature engine 210 can correlate the detected problem to one or more sources. The problem signature is indicative of a detected problem correlated with one or more sources (e.g., a database lock error with a storage error). In some embodiments, the problem signature engine 210 can generate or derive parameters associated with the problem signature from the computing system 204 that generated the big data (e.g., type of operating system, applications, hardware identification, service level agreement, etc.). The parameters can be indicative of constraints associated with the generated problem signature (e.g., time period when the problem needs to be addressed).

At block 320, the problem signature is transmitted to one or more identified cognitive engines 216. The bid engine 212 can identify registered cognitive engines 216 known to the problem auctioneer server 208. The bid engine 212 transmits the problem signature and associated parameters to the identified cognitive engines 216 to solicit bids to resolve the problem.

At block 325, bids are received from the identified cognitive engines 216. The bid engine 212 receives the bids generated by the identified cognitive engines 216 and analyzes the bids to identify the best bid received.

At block 330, one or more bids can be discarded based on predetermined criteria. The bid engine 212 can process the received bids and determine to discard one or more bids based on criteria set by a user. For example, the bid engine 212 can determine to discard bids that are below a predetermined threshold, using, for example, confidence scores associated with the bids.

At block 335, the bid engine determines whether there are any bids left after discarding one or more received bids. If at block 335, the bid engine 212 determines that there are no bids left, then the method 300 can proceed to block 340, where the problem signature is flagged to be escalated to an administrator for further review.

If at block 335, the bid engine 212 determines that there are bids left, the bid engine 212 can select the best bid. Once the best bid is selected, as shown at block 345, an action can be initiated to facilitate the resolution of the problem. The action can include selecting the associated cognitive engine 216 that generated the selected bid and transmitting the big data generated by the computing system 204 from which the problem was detected to the selected cognitive engine 216.

The present disclosure can be a system, a method, and/or a computer program product. The computer program product can include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method for dynamic problem assignment, the method comprising:
receiving a data set from a computer system;
detecting a problem based on the data set;
generating a problem signature based on the problem;
transmitting the problem signature to a plurality of cognitive engines;
receiving a plurality of bids from the plurality of cognitive engines;
selecting a bid from the plurality of bids; and
initiating an activity to intervene on the problem, wherein the activity is determined based on the selected bid.

2. The computer-implemented method of claim 1, further comprising:
discarding at least one bid from the plurality of bids based on predetermined criteria.

3. The computer-implemented method of claim 1, further comprising:
generating problem parameters based on information associated with the computer system; and
transmitting the problem parameters with the problem signature to the plurality of cognitive engines.

4. The computer-implemented method of claim 1, wherein the activity includes transmitting the data set from the computer system to the cognitive engine associated with the bid and instructing the cognitive engine to resolve the problem.

5. The computer-implemented method of claim 1, wherein the data set is a first data set and the method further comprises:
receiving a second data set from a computer system;
detecting a second problem based on the second data set;
generating a second problem signature based on the second problem;
determining that the problem signature and the second problem signature are the same; and
transmitting the second data set to the cognitive engine.

6. The computer-implemented method of claim 5, further comprising:
determining that the second problem occurred within a predetermined time threshold from the problem; and
transmitting the second data set to the cognitive engine in response to a determination that the second problem occurred within the predetermined time threshold from the problem.

7. The computer-implemented method of claim 1, wherein each bid of the plurality of bids includes a respective confidence score and wherein the method further comprises selecting the bid from the plurality of bids based on the respective confidence score associated with each bid of the plurality of bids.

8. A computer program product comprising a non-transitory storage medium readable by a processing circuit and storing instructions for execution by the processing circuit for performing a method comprising:
receiving a data set from a computer system;
detecting a problem based on the data set;
generating a problem signature based on the problem;
transmitting the problem signature to a plurality of cognitive engines;
receiving a plurality of bids from the plurality of cognitive engines;
selecting a bid from the plurality of bids; and
initiating an activity to intervene on the problem, wherein the activity is determined based on the selected bid.

9. The computer program product of claim 8, wherein the method further comprises:
discarding at least one bid from the plurality of bids based on predetermined criteria.

10. The computer program product of claim 8, wherein the method further comprises:
generating problem parameters based on information associated with the computer system; and
transmitting the problem parameters with the problem signature to the plurality of cognitive engines.

11. The computer program product of claim 8, wherein the activity includes transmitting the data set from the computer system to the cognitive engine associated with the bid and instructing the cognitive engine to resolve the problem.

12. The computer program product of claim 8, wherein the data set is a first data set and the method further comprises:
receiving a second data set from a computer system;
detecting a second problem based on the second data set;
generating a second problem signature based on the second problem;
determining that the problem signature and the second problem signature are the same; and
transmitting the second data set to the cognitive engine.

13. The computer program product of claim 12, wherein the method further comprises:
determining that the second problem occurred within a predetermined time threshold from the problem; and
transmitting the second data set to the cognitive engine in response to a determination that the second problem occurred within the predetermined time threshold from the problem.

14. The computer program product of claim 8, wherein each bid of the plurality of bids includes a respective confidence score and wherein the method further comprises selecting the bid from the plurality of bids based on the respective confidence score associated with each bid of the plurality of bids.

15. A system, comprising:
a processor in communication with one or more types of memory, the processor configured to:
receive a data set from a computer system;
detect a problem based on the data set;
generate a problem signature based on the problem;
transmit the problem signature to a plurality of cognitive engines;
receive a plurality of bids from the plurality of cognitive engines;
select a bid from the plurality of bids; and
initiate an activity to intervene on the problem, wherein the activity is determined based on the selected bid.

16. The system of claim 15, wherein the processor is further configured to:
discard at least one bid from the plurality of bids based on predetermined criteria.

17. The system of claim 15, wherein the processor is further configured to:
generate problem parameters based on information associated with the computer system; and
transmit the problem parameters with the problem signature to the plurality of cognitive engines.

18. The system of claim 15, wherein the activity includes transmitting the data set from the computer system to the cognitive engine associated with the bid and instructing the cognitive engine to resolve the problem.

19. The system of claim 15, wherein the data set is a first data set and the processor is further configured to:
receive a second data set from a computer system;
detect a second problem based on the second data set;
generate a second problem signature based on the second problem;
determining that the problem signature and the second problem signature are the same; and
transmit the second data set to the cognitive engine.

20. The system of claim 19, wherein the processor is further configured to:
determine that the second problem occurred within a predetermined time threshold from the problem; and
transmit the second data set to the cognitive engine in response to a determination that the second problem occurred within the predetermined time threshold from the problem.
